(19) United States
(12) Patent Application Publication
(10) Pub. No.: US 2017/0023223 A1
(43) Pub. Date: Jan. 26, 2017

(54) String Light Device

(71) Applicant: Ching-Tien TSAI, TAICHUNG City (TW)

(72) Inventor: Ching-Tien TSAI, TAICHUNG City (TW)

(21) Appl. No.: 14/804,561

(22) Filed: Jul. 21, 2015

(51) Int. Cl. F21V 23/06; F21V 23/00; F21S 9/02; F21S 4/00

(52) U.S. Cl. CPC F21V 23/06; F21S 4/001; F21V 23/001; F21V 23/003; F21S 9/02; F21Y 2103/003

(57) ABSTRACT

A string light device contains: a first cable, a second cable, and plural LED elements. The first cable includes a first part comprised of plural first electrical wires bound together and includes a first insulation layer covered around the first part and having plural first notches equidistantly arranged on the first insulation layer to expose the first part. The second cable includes a second part comprised of plural second electrical wires bound together and includes a second insulation layer covered around the second part and having plural second notches equidistantly arranged on the second insulation layer to expose the second part. Each LED elements is disposed in each of the plural first notches and the plural second notches and has a first contact point for electrically connecting with the first part and has a second contact point for electrically coupling with the second part.

### FIELD OF THE INVENTION

The present invention relates to a string light device which avoids breaking plural first and second electrical wires to electrically conduct an electric circuit of each LED element well.

### BACKGROUND OF THE INVENTION

Referring to FIGS. 1 and 2, a conventional string light device 10 is disclosed in TW Publication No. M364176 and contains a first cable 11, a second cable 12, and a plurality of LED elements 13. The first cable 11 includes a first part 111 made of a single copper wire and includes a first insulation layer 112 covered on the first part 111. The second cable 12 includes a second part 121 made of a single copper wire and includes a second insulation layer 122 covered on the second part 121. The first insulation layer 112 has plural first recessed portions defined thereon to expose the first part 111, and the second insulation layer 222 has plural second recessed portions formed thereon to expose the second part 121. The first part 111 has plural first flat contact areas 113 arranged thereon, and the second part 121 has plural second flat contact areas 123 arranged thereon. Each LED element 12 has a first contact pin 131 and a second contact pin 132, wherein the first contact pin 131 and the second contact pin 132 of each LED element 13 are electrically connected with each of the plural first flat contact areas 113 and each of the plural second flat contact areas 123 by using an electricity conducting glue 14, and a transparent covering glue 15 is covered on each LED element 13, each of the plural first flat contact areas 113, and each of the plural second flat contact areas 123 to insulate and protect each LED element 13. Preferably, the first cable 11 and the second cable 12 are twisted and bound on various objects and are electrically connected with a power source, thus emitting lights from each LED element 13. However, the conventional string light device 10 has defects as follows:

1. The electricity conducting glue 14 is coated on the first insulation layer 112 of the first cable 11 and the second insulation layer 122 of the second cable 12 to electrically couple the first contact pin 131 and the second contact pin 132 of each LED element 13, but the electricity conducting glue 14 cannot attach on the plural first flat contact areas 113 and the plural second flat contact areas 123 fixedly, so the first contact pin 131 and the second contact pin 132 of each LED element 13 remove from each first flat contact area 113 and each second flat contact area 123 easily.

2. The first part 111 of the first cable 11 and the second part 121 of the second cable 12 are made of the single copper wire, so they are broken easily.

The present invention has arisen to mitigate and/or obviate the afore-described disadvantages.

### SUMMARY OF THE INVENTION

The primary objective of the present invention is to provide a string light device which avoids breaking plural first and second electrical wires to electrically conduct an electric circuit of each LED element well.

Another objective of the present invention is to provide a string light device in which each of the first part and the second part has a rough surface for electrically connecting the first contact point and the second contact point of each LED element with the first part and the second part stably.

To achieve above-mentioned objectives, a string light device provided by the present invention contains: a first cable, a second cable, and a plurality of LED elements.

The first cable includes a first part comprised of plural first electrical wires twisted and bound together, and the first cable also includes a first insulation layer covered around the first part, wherein the first insulation layer has plural first notches arranged thereon to expose the first part.

The second cable includes a second part comprised of plural second electrical wires twisted and bound together, and the second cable also includes a second insulation layer covered around the second part, wherein the second insulation layer has plural second notches equidistantly arranged thereon to expose the second part.

Each of the plurality of LED elements is disposed in each of the plural first notches and the plural second notches, wherein each LED element has a first contact point for electrically connecting with the first part and has a second contact point for electrically coupling with the second part.

### BRIEF DESCRIPTION OF THE DRAWINGS

FIG. 1 is a perspective view of a conventional string light device.

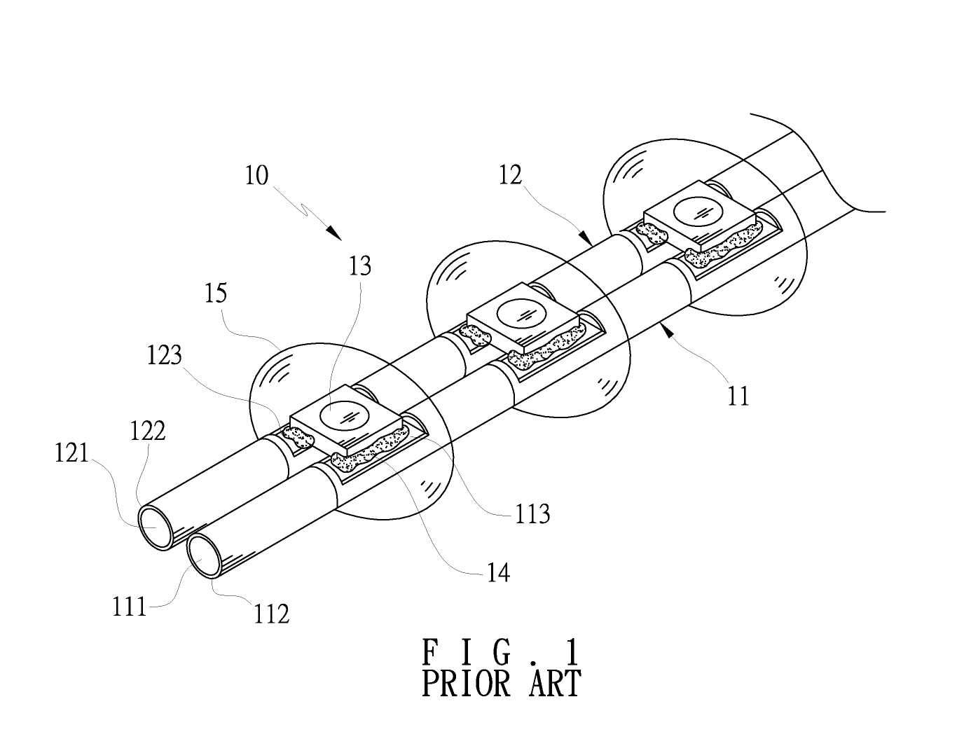

FIG. 2 is a cross sectional view of a part of the conventional string light device.

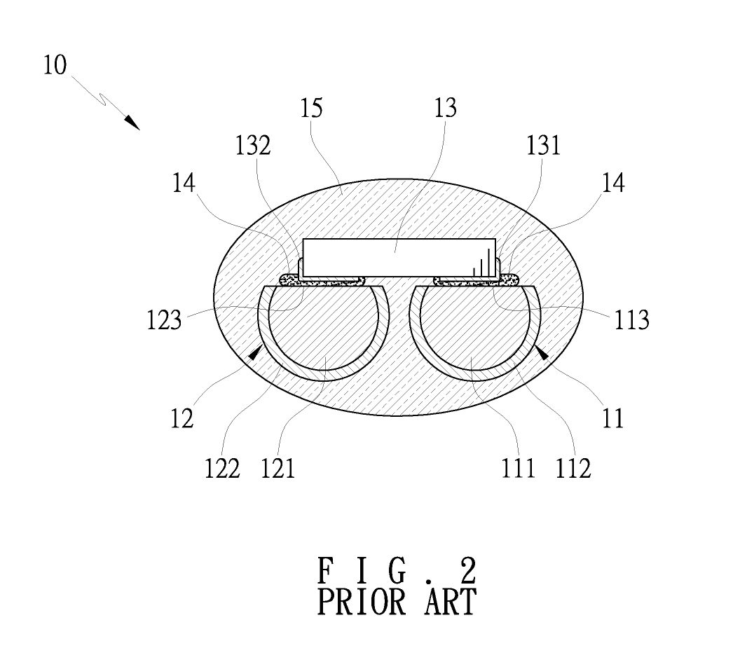

FIG. 3 is a perspective view showing the assembly of a string light device according to a first embodiment of the present invention.

FIG. 4 is a cross sectional view showing the assembly of a part of the string light device according to the first embodiment of the present invention.

FIG. 5 is a perspective view showing the application of the string light device according to the first embodiment of the present invention.

FIG. 6 is a cross sectional view showing the application of the string light device according to the first embodiment of the present invention.

FIG. 7 is a cross sectional view showing the application of a string light device according to a second embodiment of the present invention.

FIG. 8 is a perspective view showing the application of a string light device according to a third embodiment of the present invention.

FIG. 9 is another perspective view showing the application of the string light device according to the third embodiment of the present invention.

FIG. 10 is a perspective view showing the application of a string light device according to a fourth embodiment of the present invention.

### DETAILED DESCRIPTION OF THE PREFERRED EMBODIMENTS

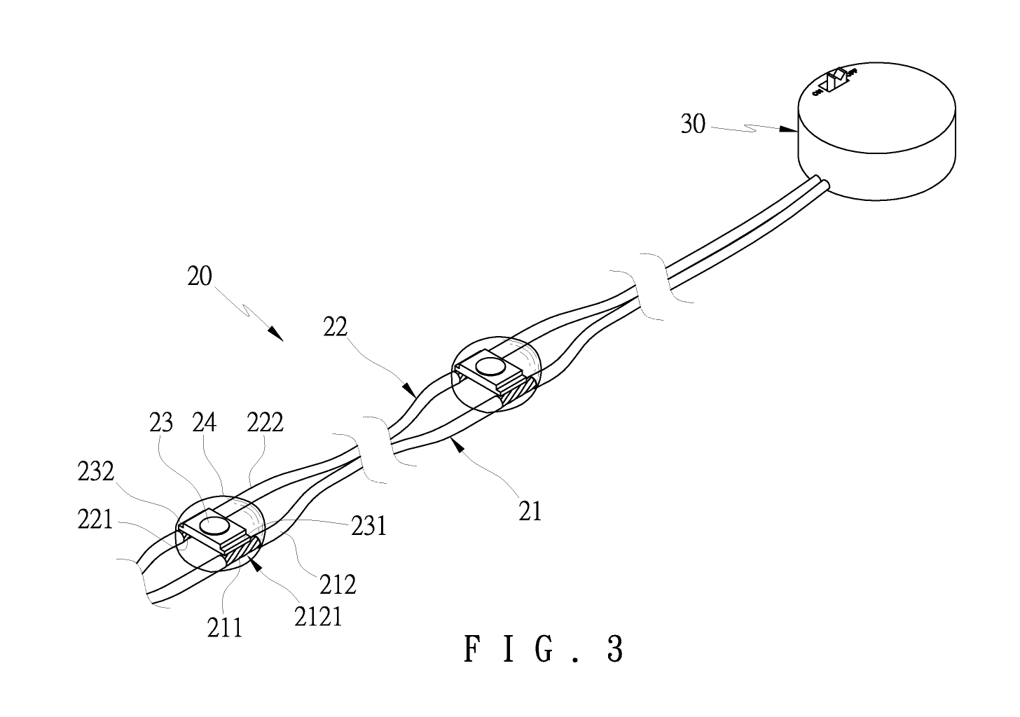

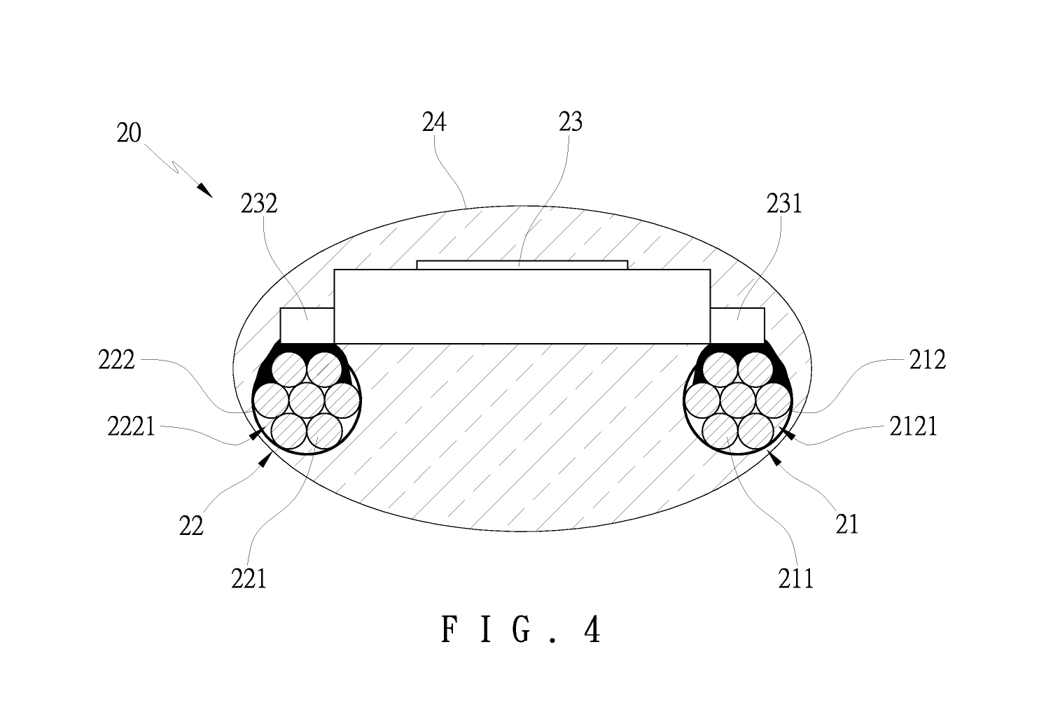

With reference to FIGS. 3 and 4, a string light device 20 according to a first embodiment comprises: a first cable 21, a second cable 22, a plurality of LED elements 23, and a controller 30. The first cable 21 includes a first part 211 comprised of plural first electrical wires twisted and bound together, and the first cable 21 also includes a first insulation layer 212 covered around the first part 211, wherein the first insulation layer 212 has plural first notches 2121 equidistantly arranged thereon, such that the first part 211 exposes outside the plural first notches 2121 of the first insulation layer 212. The second cable 22 includes a second part 221 comprised of plural second electrical wires twisted and bound together, and the second cable 22 also includes a second insulation layer 222 covered around the second part 221, wherein the second insulation layer 222 has plural second notches 2221 equidistantly arranged thereon, such that the second part 221 exposes outside the plural second notches 2221 of the second insulation layer 222. Each of the plural first notches 2121 and the plural second notches 2221 has each of the plurality of LED elements 23 disposed therein, wherein each LED element 23 has a first contact point 231 for electrically connecting with the first part 211 and has a second contact point 232 for electrically coupling with the second part 221. In this embodiment, the first contact 231 and the second contact 232 of each LED element 23 are electrically connected with the first part 211 and the second part 221 in a welding manner. Preferably, the first part 211 of the first cable 21 is comprised of the plural first electrical wires which are twisted and bound together, and the second part 221 of the second cable 22 is comprised of the plural second electrical wires which are twisted and bound together, such that each of the first part 211 and the second part 221 has a rough surface for electrically connecting the first contact point 231 and the second contact point 232 of each LED element with the first part 211 and the second part 221 stably. It is to be noted that a transparent protecting glue 24 covers each of the plural first notches 2121, each of the plural second notches 2221, and each LED element 23 to provide electrical insulation and protect each LED element 23. In addition, the first part 211 of the first cable 21 and the second part 221 of the second cable 22 allow electrically connecting with a power source or a battery to drive each LED element 23 to emit lights, and the controller 30 controls a turning on/off of each LED element 23. In this embodiment, the controller 30 includes at least one battery fixed thereon to output electric energy toward each LED element 23, such that each LED element 23 is driven to emit the lights.

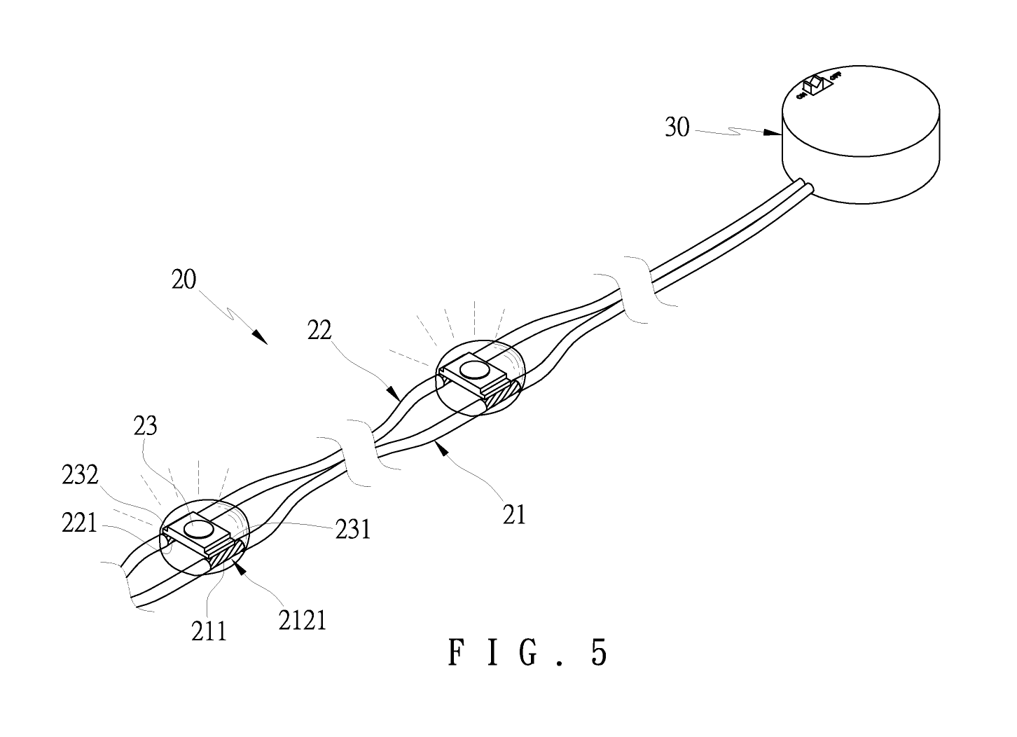

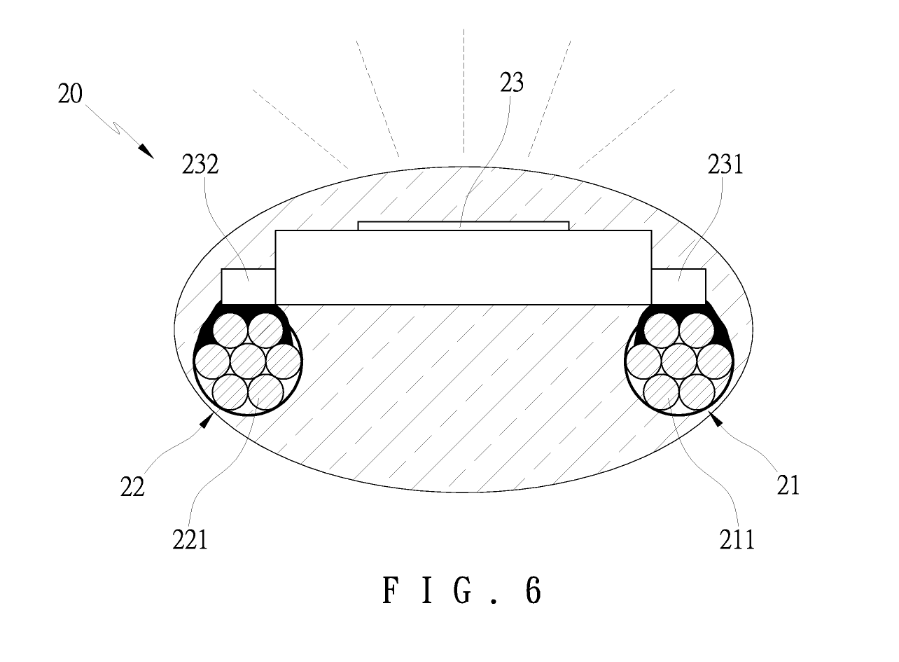

Referring to FIGS. 5 and 6, the string light device 20 is bound on various objects to emit the lights for decoration. Since the first part 211 of the first cable 21 is comprised of the plural first electrical wires which are twisted and bound together, and the second part 221 of the second cable 22 is comprised of the plural second electrical wires which are twisted and bound together, hence when the first part 21 and the second part 22 are pulled by external force, the plural first and second electrical wires are not broken to electrically conduct an electric circuit of each LED element 23.

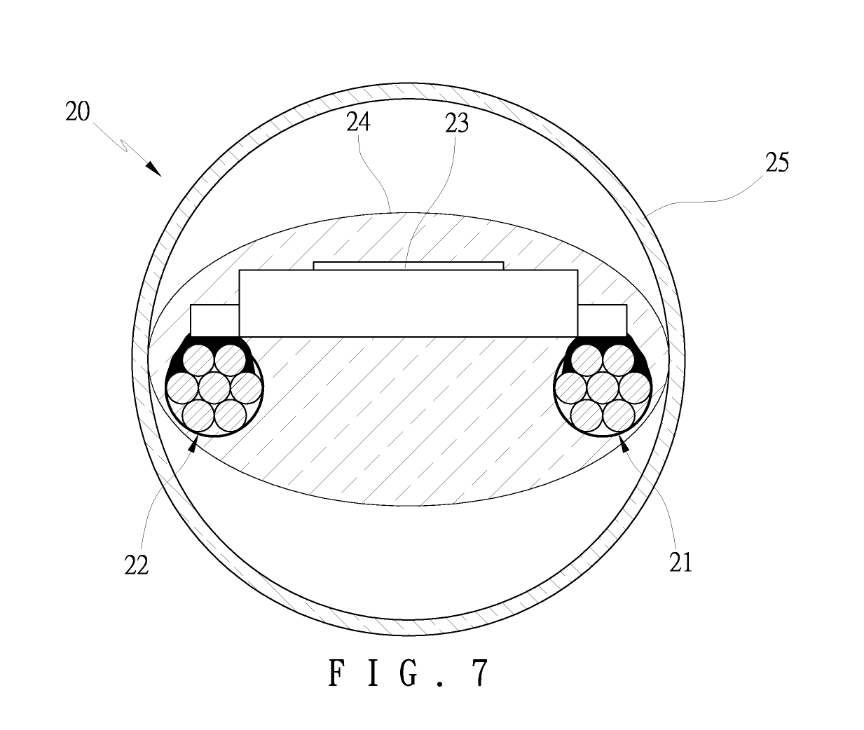

As shown in FIG. 7, a flexibly transparent tube 25 is fitted on the transparent protecting glue 24 which covers on the first cable 21, the second cable 22, and each LED element 23 to obtain protection and aesthetics appearance.

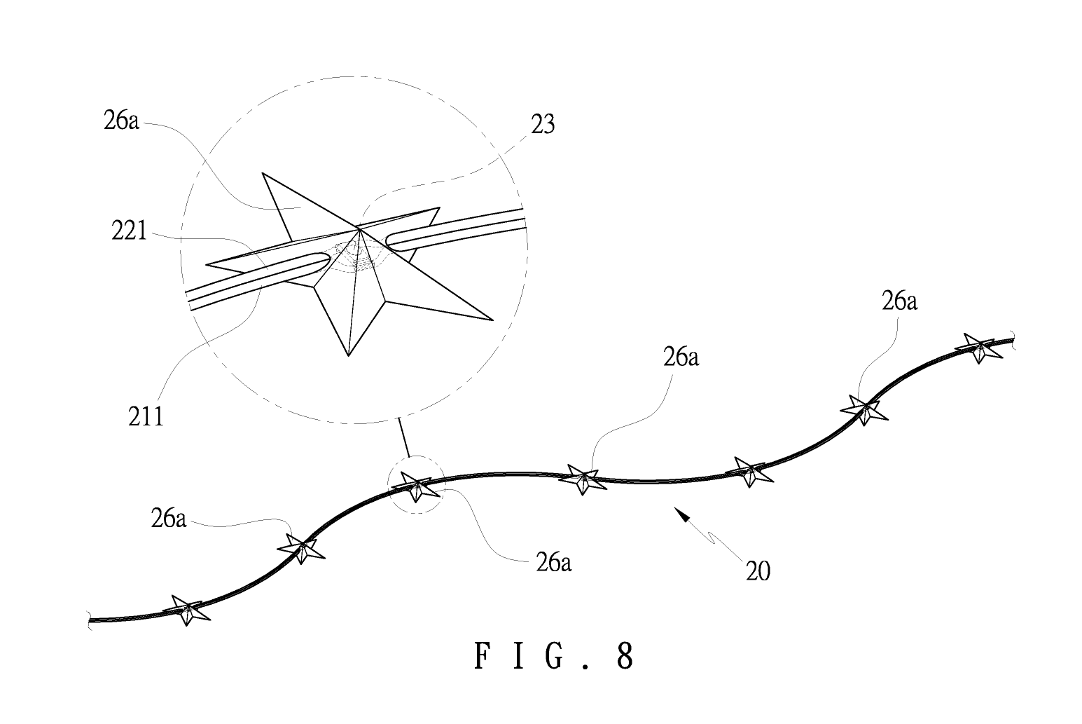

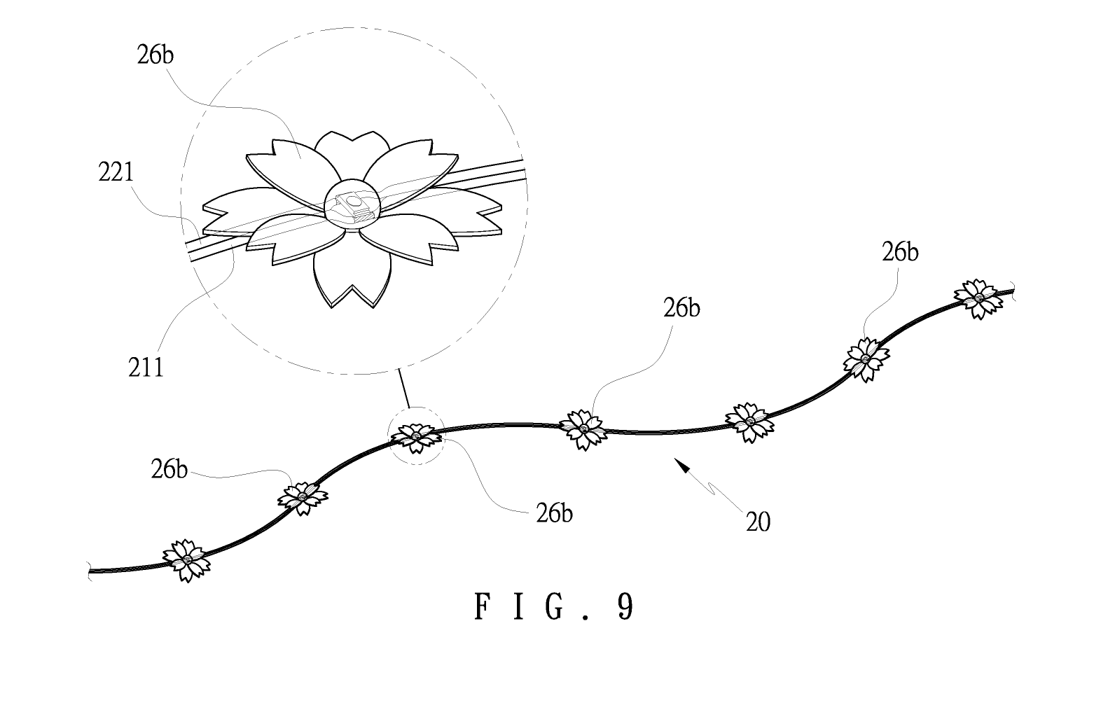

As illustrated in FIGS. 8 and 9, a transparent cover formed in any one of a star shape, a leaf shape, and a flower shape is covered on each LED element 23 of the string light device 29. With reference to FIG. 8, a transparent cover 26a formed in the star shape is covered on each LED element 23 of the string light device 20. Referring to FIG. 9, a transparent cover 26b formed in the leaf shape is covered on each LED element 23 of the string light device 20, such that each LED element 23 illuminates the lights through the transparent cover 26a or 26b, thus obtaining decoration effect.

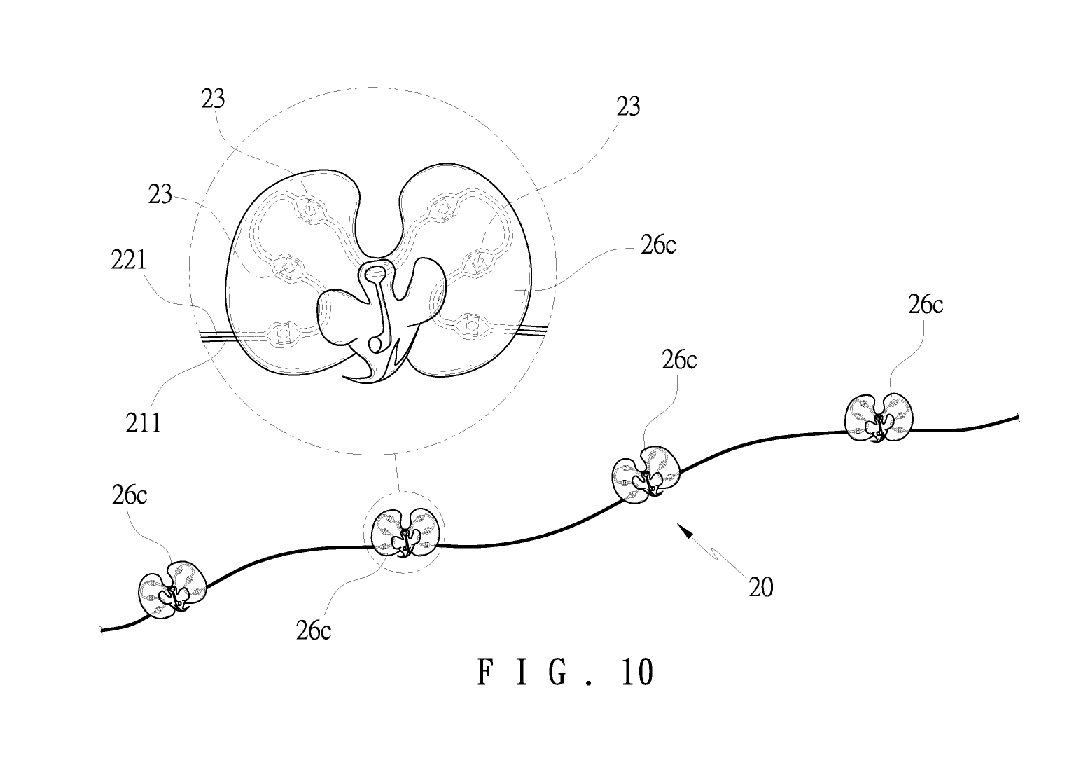

As shown in FIG. 10, a transparent cover 26c formed in the flower shape is covered on each LED element 23 of the string light device 20, such that each LED element 23 illuminates the lights through the transparent cover 26c, thus enhancing decoration effect.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A string light device comprising:
a first cable including a first part comprised of plural first electrical wires twisted and bound together, and the first cable also including a first insulation layer covered around the first part, wherein the first insulation layer has plural first notches arranged thereon to expose the first part;
a second cable including a second part comprised of plural second electrical wires twisted and bound together, and the second cable also including a second insulation layer covered around the second part, wherein the second insulation layer has plural second notches equidistantly arranged thereon to expose the second part;
a plurality of LED elements, each of which is disposed in each of the plural first notches and the plural second notches, wherein each LED element has a first contact point for electrically connecting with the first part and has a second contact point for electrically coupling with the second part.

2. The string light device as claimed in claim 1, wherein the first insulation layer of the first part has the plural first notches equidistantly arranged thereon, and the second insulation layer of the second part has the plural second notches equidistantly arranged thereon.

3. The string light device as claimed in claim 1, wherein the first contact and the second contact of each LED element are electrically connected with the first part and the second part in a welding manner.

4. The string light device as claimed in claim 1, wherein a transparent protecting glue covers each of the plural first notches, each of the plural second notches, and each LED element.

5. The string light device as claimed in claim 1 further comprising a controller for controlling a turning on/off of each LED element.

6. The string light device as claimed in claim 5, wherein the controller includes at least one battery fixed thereon to output electric energy toward each LED element.

7. The string light device as claimed in claim 1, wherein a flexibly transparent tube is fitted on the transparent protecting glue which covers on the first cable, the second cable, and each LED element.

8. The string light device as claimed in claim 1, wherein a transparent cover is covered on each LED element.
